(19) United States
(12) Patent Application Publication
(10) Pub. No.: US 2005/0033585 A1
(43) Pub. Date: Feb. 10, 2005

(54) Semiconductor chip for a mobile telephone which includes a text to speech system, a method of aurally presenting information from a mobile telephone and a mobile telephone

(76) Inventor: Paul William Shields, Livingston (GB)

Correspondence Address: OLIFF & BERRIDGE, PLC, P.O. BOX 19928, ALEXANDRIA, VA, 22320, US

(21) Appl. No.: 10/485,076

(22) PCT Filed: Jun. 12, 2003
(86) PCT No.: PCT/GB03/02554

(30) Foreign Application Priority Data
Jun. 13, 2002 (GB) 0213627.3

(51) Int. Cl. G10L 19/00

(52) U.S. Cl. 704/500

(57) ABSTRACT

Mobile telephones are not only able to make and receive telephone calls and send text messages but are increasingly being developed with additional functions. These include the ability to play music, access the Internet and/or play games. Digital music formats such as MP3 or ATRAC have the ability to store information within the encoded music stream. Such information can comprise the name of the track, album, musician, singer etc. It is envisaged that mobile telephones could be provided with TTS systems. The present invention is directed towards a mobile telephone in combination with a TTS system which is used to present information regarding music or a game being played or information from the Internet. The present invention thus relates to a semiconductor chip and method of aurally presenting information from a mobile telephone which includes TTS system, comprising: selecting when said information is presented aurally; separating said information from said data stream; providing said information to said TTS; and aurally presenting said information.

The present invention relates to a semiconductor chip for use in a mobile telephone which includes a text to speech (TTS) system, a method of aurally presenting information from a mobile telephone and a mobile telephone.

Mobile telephones are not only able to make and receive telephone calls and send text messages but are increasingly being developed with additional functions. These include the ability to play music, access the internet and/or play games.

Digital music formats such as MP3 or ATRAC have the ability to store information within the encoded music stream. Such information can comprise the name of the track, album, musician, singer etc.

It is well known that games often include information such as game over, next level or the scores, to be conveyed to the user.

Hitherto, such information concerning the music being played or particularly the game information has been displayed on the screen of the mobile telephone. Screens of mobile telephones are so small such that there is little or no room to present the information properly. Increasingly, mobile telephones are being used in environments where it is difficult to access or view the screen. For example, mobile telephones are usually carried in a pocket or bag or used in a hands free situation which makes it difficult to view the information being presented on the screen.

Recently, there have been significant developments in text to speech (TTS) systems in many electrical devices. A text to speech (TTS) system converts text to speech and involves determining the correct pronunciation. In addition to the correct pronunciation, many TTS systems control how the text is spoken by defining a particular speech mode. A speech mode may be defined as to at least the prosody, i.e. the speech rhythms, stresses on various words, changes in pitch, rate of speaking, changes in volume and how the text is spoken in terms of currency values, dates, times etc amongst other features.

Hitherto, such TTS systems have not been used in mobile telephones but it is envisaged that mobile telephones could be provided with TTS systems. Thus, the present invention is directed towards a mobile telephone in combination with a TTS system which is used to present information regarding music or a game being played or information from the Internet.

Thus, an aim of the present invention is to provide a semiconductor chip, a method and a mobile telephone which aurally presents information.

The present invention relates to a semiconductor chip for use in a mobile telephone which includes a text to speech (TTS) system, said chip includes:
control means for separating information from a data stream; and
channel means for passing said information to said TTS and in which said channel means includes a switch for selectively passing said information to said TTS, thereby enabling said TTS to aurally present said information.

The present invention also relates to a method of aurally presenting information from a mobile telephone which includes a TTS system, said information being contained within a data stream, method comprising:
selecting when said information is presented aurally;
separating said information from said data stream;
providing said information to said TTS; and
aurally presenting said information.

Finally, the present invention includes a mobile telephone including a text to speech (TTS) system coupled to a semiconductor chip as claimed in the attached claims.

Embodiments of the present invention will now be described by way of further example only and with reference to the accompanying drawings, in which:

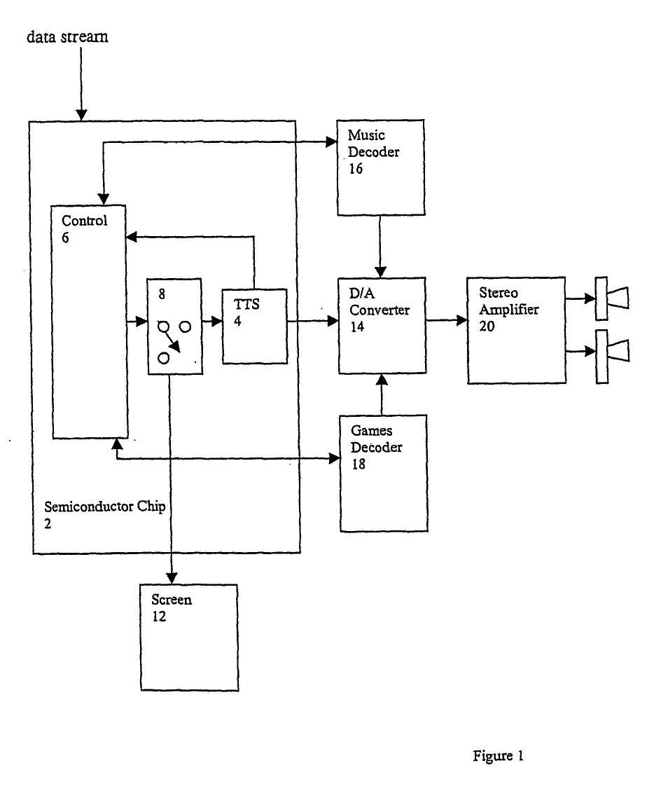

FIG. 1 is a schematic diagram of part of a mobile telephone according to the present invention;

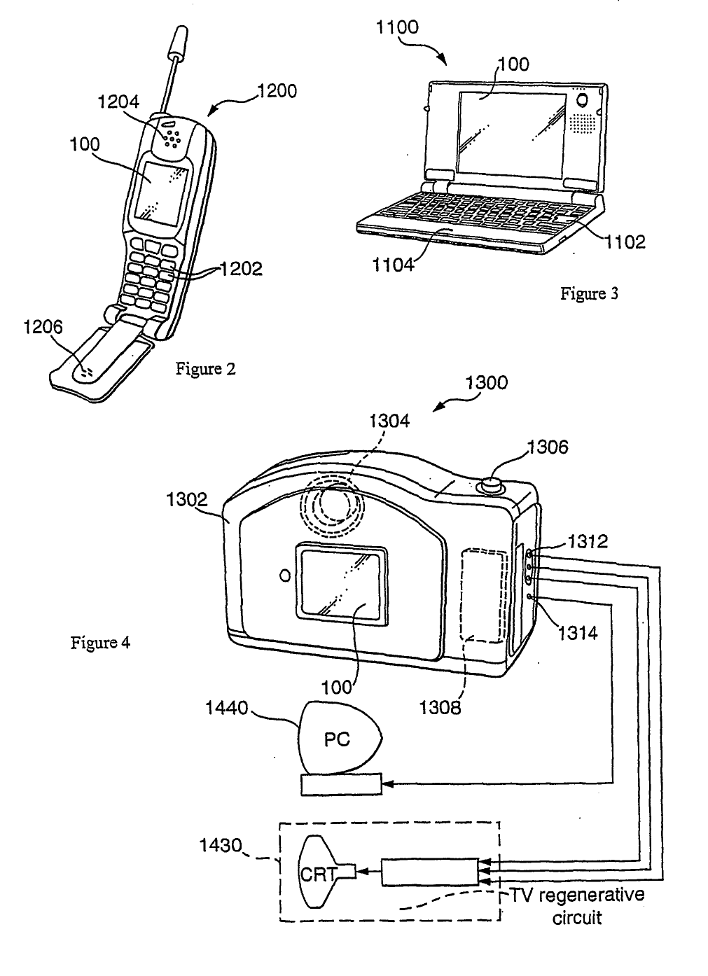

FIG. 2 is a schematic view of a mobile telephone according to the present invention;

FIG. 3 is a schematic view of a mobile personal computer according to the present invention; and

FIG. 4 is a schematic view of a digital camera according to the present invention.

FIG. 1 illustrates a semiconductor chip 2 in which a TTS system 4 is embedded. The chip 2 also includes a control 6. A data stream is received by the semiconductor chip 2. The chip separates information from the data stream. When the data stream comprises pieces of music, then the information may include details of the particular piece of music or track, the album from which it is taken, the musician or singer. When the data stream comprises a game, the information may comprise key stages of the game such as game over or game starting or character selection or scenario selection or any change in the score.

The control means 6 provides said information to a channel 8. The channel includes a switch 10. The switch enables the information to be output aurally or visually or not at all. The switch enables the information to be passed to the TTS 4 to be presented aurally or to a screen 12 for visual presentation.

The mobile telephone includes a digital to analogue (D/A) converter 14 coupled to the semiconductor chip 2. The mobile telephone furthermore includes a music decoder 16 which is coupled to the semiconductor chip 2 and D/A converter 14. The mobile telephone also includes a games decoder 18 which is also coupled to the semiconductor chip 2 and D/A converter 14. This embodiment discloses both a music decoder and a games decoder but the present invention may be applied when there is only one decoder either music or games or neither if the mobile telephone is capable of including such functions over the Internet.

The D/A converter receives digital signals from the music decoder 16, the games decoder 18 and the TTS system 4 and outputs analogue signals to a stereo amplifier 20. The stereo amplifier outputs the music or games sounds or text from the TTS system.

In operation, the control 6 receives the data stream and separates the information therefrom. The control 6 also receives interrupts from the music decoder 16 and the games decoder 18. The interrupts indicate whether it is a convenient time to output the information. The control 6 determines the timing as to when the user is notified of the information as well as whether the information is aurally presented or visually presented.

If there is information to be presented, then the control waits to receive an interrupt. If the information is to be presented aurally, then when the interrupt is received, the information is output to the TTS system 4. The TTS system outputs the encoded information to the D/A converter which converts the signal and the converted analogue signal is passed to the stereo amplifier to output the information aurally. If the information is to be presented visually, when the interrupt is received, the information is output to the screen.

When the interrupt is received from the music decoder, then this indicates the end of one piece of music and before the start of another. When the interrupt is received from the games decoder, then this indicates a key stage in the game. A key stage is such as game over or game starting or character selection or scenario selection or any change in the score.

When information is to be presented from the games decoder, then it is particularly advantageous to use the TTS system since more information can be presented when compared to using the screen. This is because the screen is more limited and so more information can be conveyed at any one time. The ability to use the TTS system to present information to the user thus enables an improvement in the quality and complexity of games and may even enable an additional dimension to the game. In addition, if mulitplayer games are involved, then the information may enable certain key stages to be output to one or more of the players but not others.

Finally, when the TTS system has finished outputting the information, then the TTS system advises the control 6. The control 6, then instructs the music decoder 16 or games decoder 18 to continue.

The embodiment has been described with reference to a mobile telephone but the present invention is advantageous for use in any small, mobile electronic products which are capable of attending to other functions whilst receiving information such as, computers, CD players, DVD players and the like—although it is not limited thereto.

Several electronic products using the present invention will now be described.

<1: Mobile Phone>

FIG. 2 is an isometric view illustrating the configuration of a mobile telephone. In the drawing, the mobile telephone 1200 is provided with a plurality of operation keys 1202, an ear piece 1204, a mouthpiece 1206, and a display panel 100. The mouthpiece 1206 or ear piece 1204 may be used for outputting speech.

<2: Mobile Computer>

FIG. 3 is an isometric view illustrating the configuration of a personal computer. In the drawing, the personal computer 1100 is provided with a body 1104 including a keyboard 1102 and a display unit 1106.

<3: Digital Still Camera>

Next, a digital still camera using the present invention will be described. FIG. 4 is an isometric view illustrating the configuration of the digital still camera and the connection to external devices in brief.

Typical cameras sensitise films based on optical images from objects, whereas the digital still camera 1300 generates imaging signals from the optical image of an object by photoelectric conversion using, for example, a charge coupled device (CCD). The digital still camera 1300 is provided with an OEL element 100 at the back face of a case 1302 to perform display based on the imaging signals from the CCD. Thus, the display panel 100 functions as a finder for displaying the object. A photo acceptance unit 1304 including optical lenses and the CCD is provided at the front side (behind in the drawing) of the case 1302. The present invention may be embodied in the digital still camera.

Further examples of electronic products, other than the mobile telephone shown in FIG. 2, the computer shown in FIG. 3, and the digital still camera shown in FIG. 4, include television sets, view-finder-type and monitoring-type video tape recorders, car navigation systems, pagers, electronic notebooks, portable calculators, word processors, workstations, TV telephones, point-of-sales system (POS) terminals, and devices provided with touch panels.

In whichever situation, the present invention enables users to be advised of information embedded in a data stream either visually or aurally. This is particularly important when mobile telephones are being used to play music, games or access the internet or when difficult to view or access, such as being in a pocket or bag.

The foregoing description has been given by way of example only and it will be appreciated by a person skilled in the art that modifications can be made without departing from the scope of the present invention.

For example, the embodiment illustrated and shown is described with a semiconductor chip having an embedded TTS system. However, the semiconductor chip may not include the TTS system and this may be provided elsewhere in the mobile telephone.

In addition, the switch in channel 8 could be configured to enable the information to be presented simultaneously visually and aurally.

1. A semiconductor chip for use in a mobile telephone which includes a text to speech (TTS) system, said chip includes:
control means for separating information from a data stream; and
channel means for passing said information to said TTS and in which said channel means includes a switch for selectively passing said information to said TTS, thereby enabling said TTS to aurally present said information.

2. A method of aurally presenting information from a mobile telephone which includes a TTS system, said information being contained within a data stream, method comprising:
selecting when said information is presented aurally;
separating said information from said data stream;
providing said information to said TTS; and
aurally presenting said information.

3. A method as claimed in claim 2, wherein said method further includes:
confirming when said information presentation is completed.

4. A method as claimed in claim 2, in which said data stream comprises pieces of music and wherein said presenting aurally occurs in between the pieces of music.

5. A method as claimed in claim 4, wherein said method further includes:
determining when a said piece of music is completed and then presenting said information.

6. A method as claimed in claim 2, in which said data stream comprises a game and wherein said presenting aurally occurs at key stages of the game.

7. A method as claimed in claim 6, wherein said key stages comprises at least one of:
starting the game;
finishing the game;
selecting a game character;
selecting or commencing a game scenario;
increasing the score; or
decreasing the score.

8. A method as claimed in claim 4, in which said information comprises information about the music or the game.

9. A mobile telephone including a text to speech (TTS) system coupled to a semiconductor chip as claimed in claim 1.

10. A mobile telephone as claimed in claim 9, further comprising a music decoder coupled to said semiconductor chip for enabling said control means to determine when said piece of music is completed.

11. A mobile telephone as claimed in claim 9, further comprising a game decoder coupled to said semiconductor chip for enabling said control means to determine a key stage in a game.

12. A mobile telephone as claimed in claim 9, in which said TTS system advises said semiconductor chip when said information presentation is completed.

13. A semiconductor chip substantially as hereinbefore described and with reference to FIG. 1.

14. A method of aurally presenting information substantially as hereinbefore described and with reference to FIG. 1.

15. A mobile telephone substantially as hereinbefore described and with reference to either figures 1 or 2.
